(19) United States
(12) Patent Application Publication
(10) Pub. No.: US 2009/0163295 A1
(43) Pub. Date: Jun. 25, 2009

(54) GOLF CLUB HEAD WITH A SHOCK-ABSORBER AND METHOD FOR MANUFACTURING THE SAME

(76) Inventor: Wen-Cheng Tseng, Kaohsiung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/110,716

(22) Filed: Apr. 28, 2008

(30) Foreign Application Priority Data
Dec. 25, 2007 (TW) 096150120

(51) Int. Cl. A63B 53/04; B23P 25/00

(52) U.S. Cl. 473/346; 473/332; 29/530; 29/525.11

(57) ABSTRACT

A golf club head has a body, a shock absorber and a plug assembly. The body has multiple faces, an inner chamber, an injection base and at least one discharging hole. The injection base is formed on one of the faces beside the front and has an injection hole defined through the injection base and communicating with the inner chamber. The shock-absorber is hollow, is mounted in the inner chamber and tightly abuts with the inner surface of the inner chamber and the hitting plate. The plug assembly is securely mounted in the injection base and has an airtight inflating pad and a plug base. The airtight inflating pad is mounted in the injection hole and seals a passage between the injection hole and the inner chamber. The plug base is mounted in the injection hole and presses against the airtight inflating pad.

### BACKGROUND OF THE INVENTION

1. Field of the Invention

The present invention relates to a golf club head, and more particularly to a golf club head with a shock absorber and a method for manufacturing the same.

2. Description of Related Art

To improve shock-absorbing effect, a conventional golf club head is always provided with a shock-absorber inside the head to keep shock occurring during hitting a golf ball from being transmitting to a golf player. For example, U.S. Pat. No. 7,281,989, entitled to “Golf Club Head With Gas Cushion” provided a conventional golf club with a shock-absorber implemented with at least one gas cushion.

To mount a shock-absorber into the golf club head, an air cell containing compressed air with a pressure level is pressed into a hollow body of the golf club head via an opening. Then, a board is securely attached to the body to close the opening with a welding or pressing process. With the pressure in the air cell, a shock-absorbing effect is provided.

However, because the air cell is made of rubber or plastic material, the air cell is easily broken during the welding process and air will release from the broken cell. Additionally, the air cell cannot tightly and fully contact with a hitting plate of the golf club head, so the shock-absorbing effect of the conventional golf club head is decrease even completely lost.

If the board is attached to the body with a pressing process, the board is easily detached from the opening of the body due to the rebound force provided by the pressure in the air cell. The conventional golf club head is not durable.

To overcome the shortcomings, the present invention tends to provide a golf club head to mitigate or obviate the aforementioned problems.

### SUMMARY OF THE INVENTION

The main objective of the invention is to provide a golf club to provide an excellent shock-absorbing effect and reduce the cost for manufacturing the golf club.

The golf club head comprises a body, a shock absorber and a plug assembly. The body is hollow and has multiple faces, an inner chamber, an injection base and at least one discharging hole. The faces include a front provided with a hitting plate. The inner chamber is defined in the hollow body and has an inner surface. The injection base is formed on one of the faces beside the front and has an injection hole defined through the injection base and communicating with the inner chamber. The at least one discharging hole is defined through one of the faces beside the front and communicates with the inner chamber. The shock-absorber is hollow, is mounted in the inner chamber and tightly abuts with the inner surface of the inner chamber and the hitting plate. The plug assembly is securely mounted in the injection base and has an airtight inflating pad and a plug base. The airtight inflating pad is mounted in the injection hole in the injection base and seals a passage between the injection hole and the inner chamber. The plug base is mounted in the injection hole in the injection base and presses against the airtight inflating pad.

A method for manufacturing the golf club head comprises acts of:

forming a hollow body having a hitting plate, an inner chamber, an injection base with an injection hole and at least one discharging hole;

injecting a shock-absorbing material into the inner chamber of the body via the injection hole in the injection base;

blowing air through the injection hole to expand the shock-absorbing material to form a hollow shock-absorber according to a shape of the inner chamber and tightly abutting with an inner surface of the inner chamber and the hitting plate;

holding pressure inside the hollow shock-absorber at a level;

releasing the pressure in the hollow shock-absorber;

attaching an airtight inflating pad and a plug base into the injection hole in the injection base in sequence to seal a passage between the injection hole and the inner chamber;

pumping air into the shock-absorber at a predetermined pressure level via the airtight inflating pad; and

closing the injection hole in the injection base.

Other objects, advantages and novel features of the invention will become more apparent from the following detailed description when taken in conjunction with the accompanying drawings.

### BRIEF DESCRIPTION OF THE DRAWINGS

FIG. 1 is an exploded side view in partial section of a golf club head in accordance with the present invention;

FIG. 2 is a cross sectional side view of the body of the golf club head in FIG. 1;

FIG. 3 is an operational cross sectional side view of the body of the golf club head in FIG. 1 showing a material being injected into the body via the injection base;

FIG. 4 is an operational cross sectional side view of the body of the golf club head in FIG. 1 showing the material being blown;

FIG. 5 is an operational cross sectional side view of the body of the golf club head in FIG. 1 showing the material being expanded to a shape according to the shape of the inner chamber of the body;

FIG. 6 is an operational side view in partial section of the body of the golf club head in FIG. 1 showing the act of pumping air into the shock-absorber;

FIG. 7 is an operational side view in partial section of the body of the golf club head in FIG. 1 showing the act of closing the injection base with a bolt;

FIG. 8 is an operational side view in partial section of the body of the golf club head in FIG. 1 showing the act of closing the injection base with a decorative panel; and

FIG. 9 is a cross sectional side view of a second embodiment of a golf club head in accordance with the present invention.

### DETAILED DESCRIPTION OF PREFERRED EMBODIMENT

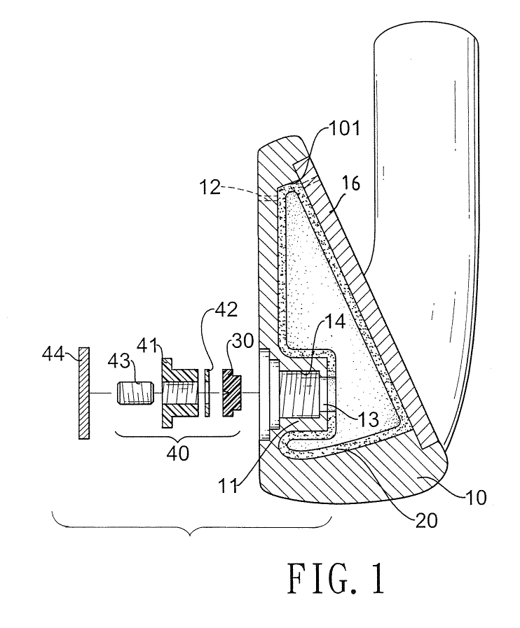

With reference to FIG. 1, a golf club head in accordance with the present invention comprises a body (10), a shock-absorber (20) and a plug assembly (40).

The body (10) is hollow and has multiple faces, an inner chamber (101), an injection base (11) and at least one discharging hole (12). The faces include a front provided with a hitting plate (16), a rear opposite to the front, a top and a bottom. The inner chamber (101) is defined in the hollow body (10) and has an inner surface. The injection base (11) is formed on one of the faces beside the front, preferably, the injection base (11) is formed on the rear of the body (10) as shown. The injection base (11) has an injection hole (14) defined through the injection base (11) and communicating with the inner chamber (101). The injection hole (14) is threaded and has a bottom through which a passage (13) between the injection hole (14) and the inner chamber (101) is defined.

The at least one discharging hole (12) is defined through one of the faces beside the front, preferably in the rear and communicates with the inner chamber (101).

The shock-absorber (20) is hollow, is mounted in the inner chamber (101) and tightly abuts with the inner surface of the inner chamber (101) and the hitting plate (16). The shock-absorber (20) contains compressed air with a pressure level to provide a shock-absorbing effect.

The plug assembly (40) is securely mounted in the injection base (11) and comprises an airtight inflating pad (30), a plug base (41), a washer (42), a bolt (43) and a decorative panel (44).

The airtight inflating pad (30) is resilient, is mounted in the injection hole (14) in the injection base (11) and seals the passage (13).

The plug base (41) is mounted in the injection hole (14) in the injection base (11) and presses against the airtight inflating pad (30). The plug base (41) has an outer thread and is screwed with the threaded injection hole (14). The plug base (41) further has a threaded hole defined axially through the plug base (41). The washer (42) is mounted between the plug base (41) and the airtight inflating pad (30). The bolt (43) is mounted in and screwed with the threaded hole in the plug base (41). The decorative panel (44) is securely mounted in the injection hole (14) in the injection base (11) and has an outer surface being flush with the face of the body (10) on which the injection base (11) is formed.

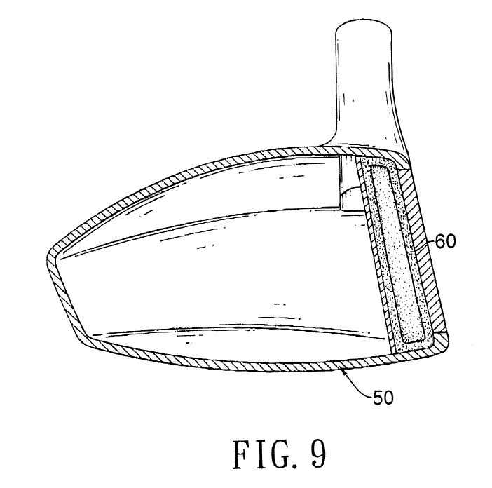

In addition, the golf club head in accordance with the present invention can be an iron club head as shown in FIG. 1 or a wooden club head (50) with a hollow shock absorber (60) as shown in FIG. 9 and is versatile in use.

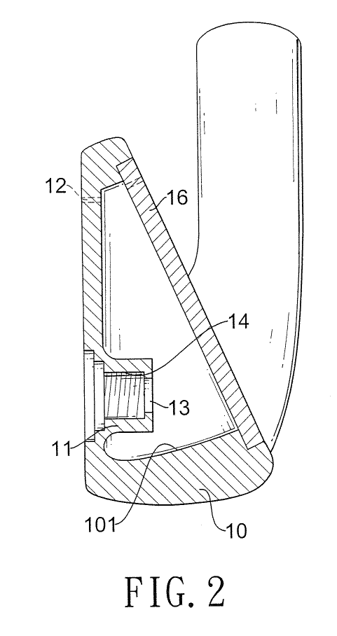

To manufacturing the golf club head, with reference to FIGS. 2 to 8, a hollow body (10) with the inner chamber (101), the injection base (11) with an injection hole (14) and the at least one discharging hole (12) is formed as shown in FIG. 2.

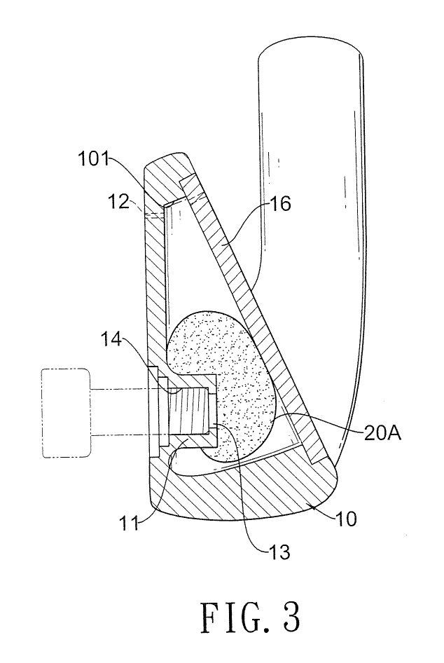

A shock-absorbing material (20A) is then injected into the inner chamber (101) of the body (10) via the injection hole (14) and passage (13) in the injection base (11) as shown in FIG. 3.

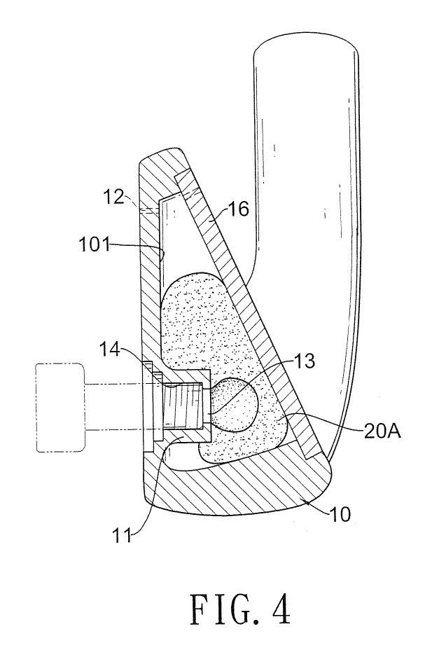

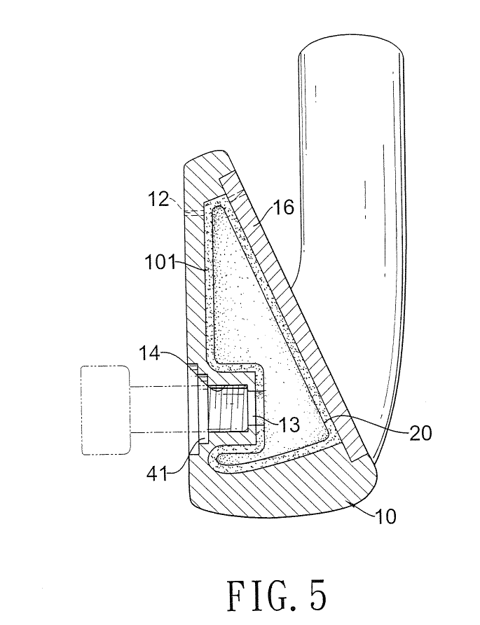

Air is blown through the injection hole (14) to expand the shock-absorbing material (20A) to form a hollow shock-absorber (20) according to a shape of the inner chamber (101) and tightly attached to an inner surface of the inner chamber ( 101) and the hitting plate (16) as shown in FIGS. 4 and 5. The air inside the air chamber (101) will be discharged from the at least one discharging hole (12) to make the shock absorber (20) abutting fully and tightly with the inner surface of the inner chamber (101) and the hitting plate (16).

Before the material (20A) is injected and expanded, the inner surface of the inner chamber (101) can be roughed by such as sandblasting process to increase the contacting area between the inner chamber (101) and the shock absorber (20). Additionally, the shock-absorbing material (20A) may comprise glue to increase the combination strength with the inner surface of the inner chamber (101) and the hitting plate (16).

Pressure inside the hollow shock-absorber (20) is held at a level for a predetermined period, and the pressure in the hollow shock-absorber (20) is released via the injection hole (14) when the holding period expires.

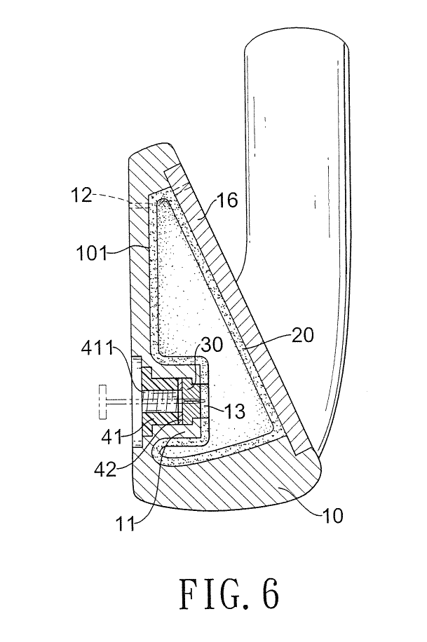

An airtight inflating pad (30) and a plug base (41) are attached into the injection hole (14) in the injection base (14) in sequence to seal the passage (13) between the injection hole (14) and the inner chamber (101) as shown in FIG. 6.

Air is pumped into the shock-absorber (20) at a predetermined pressure level via the airtight inflating pad (30) with an inflating needle.

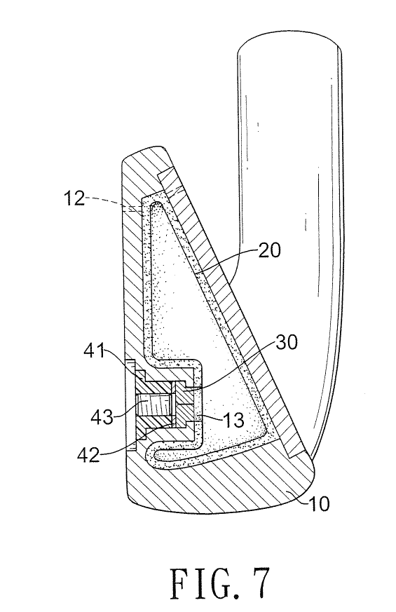

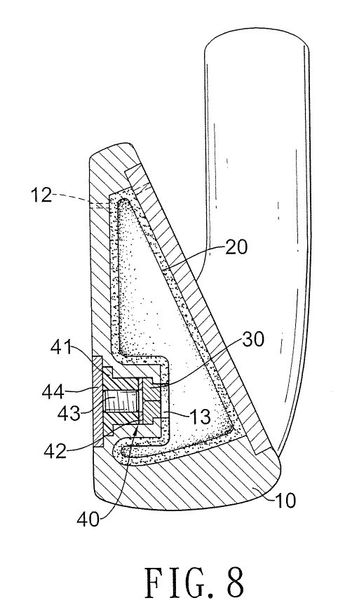

The injection hole (14) in the injection base (11) is closed as shown in FIGS. 7 and 8. To close the injection hole (14) in the injection base (11), a bolt (43) is screwed into the plug base (41) and a decorative panel (44) is then attached to the injection hole (14) with glue.

With such an arrangement, because the shock absorber (20) tightly abuts with the inner surface of the inner chamber (101) of the body, the shock generated as the golf club hitting a ball can be efficiently absorbed and eliminated with the pressure inside the shock absorber (20). The shock can be prevented from transmitting to golf players, to use the golf club is comfortable. Additionally, the shock absorber (20) is formed by process of expanding shock-absorbing material (20A) by air, the thickness of the shock absorber (20) can be reduced and amount of the material for the shock absorber (20) is decreased. Accordingly, a welding or pressing process as the conventional golf club is unnecessary, and the cost for manufacturing the golf club is reduced. Without a welding process as the conventional golf club, the shock absorber (20) is not easily broken during the manufacturing process, the pressure inside the shock absorber (20) can be held for a long period and the shock absorbing effect provided by the shock absorber (20) is enhanced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A golf club head comprising:
a hollow body having
multiple faces including a front provided with a hitting plate;
an inner chamber defined in the hollow body and having an inner surface;
an injection base formed on one of the faces beside the front and having an injection hole defined through the injection base and communicating with the inner chamber; and
at least one discharging hole defined through one of the faces beside the front and communicating with the inner chamber;
a hollow shock-absorber mounted in the inner chamber and tightly abutting with the inner surface of the inner chamber and the hitting plate; and
a plug assembly securely mounted in the injection base and comprising
an airtight inflating pad mounted in the injection hole in the injection base and sealing a passage between the injection hole and the inner chamber; and
a plug base mounted in the injection hole in the injection base and pressing against the airtight inflating pad.

2. The golf club head as claimed in claim 1, wherein the faces of the body includes a rear opposite to the front; and
the injection base and the at least one discharging hole are formed on the rear.

3. The golf club head as claimed in claim 2, wherein
the injection hole in the injection base is threaded and has a bottom through which the passage is defined; and
the plug base is screwed with the threaded injection hole.

4. The golf club head as claimed in claim 3, wherein
the plug base further has a threaded hole defined axially through the plug base; and
the plug assembly further comprises
a washer mounted between the plug base and the airtight inflating pad;
a bolt mounted in and screwed with the threaded hole in the plug base; and
a decorative panel securely mounted in the injection hole in the injection base and having an outer surface being flush with the rear of the body.

5. The golf club head as claimed in claim 1, wherein
the injection hole in the injection base is threaded and has a bottom through which the passage is defined; and
the plug base is screwed with the threaded injection hole.

6. The golf club head as claimed in claim 5, wherein
the plug base further has a threaded hole defined axially through the plug base; and
the plug assembly further comprises
a washer mounted between the plug base and the airtight inflating pad;
a bolt mounted in and screwed with the threaded hole in the plug base; and
a decorative panel securely mounted in the injection hole in the injection base and having an outer surface being flush with the face of the body on which the injection base is formed.

7. The golf club head as claimed in claim 1, wherein
the plug base further has a threaded hole defined axially through the plug base; and
the plug assembly further comprises
a washer mounted between the plug base and the airtight inflating pad;
a bolt mounted in and screwed with the threaded hole in the plug base; and
a decorative panel securely mounted in the injection hole in the injection base and having an outer surface being flush with the face of the body on which the injection base is formed.

8. A method for manufacturing a golf club head as claimed in claim 1 comprising acts of:
forming a hollow body having a hitting plate, an inner chamber, an injection base with an injection hole and at least one discharging hole;
injecting a shock-absorbing material into the inner chamber of the body via the injection hole in the injection base;
blowing air through the injection hole to expand the shock-absorbing material to form a hollow shock-absorber according to a shape of the inner chamber and tightly abutting with an inner surface of the inner chamber and the hitting plate;
holding pressure inside the hollow shock-absorber at a level;
releasing the pressure in the hollow shock-absorber;
attaching an airtight inflating pad and a plug base into the injection hole in the injection base in sequence to seal a passage between the injection hole and the inner chamber;
pumping air into the shock-absorber at a predetermined pressure level via the airtight inflating pad; and
closing the injection hole in the injection base.

9. The golf club head as claimed in claim 8, wherein the act of closing the injection hole in the injection base comprises acts of
screwing a bolt into the plug base; and
attaching a decorative panel to the injection hole with glue.
